(19) United States
(12) Patent Application Publication
(10) Pub. No.: US 2020/0310714 A1
(43) Pub. Date: Oct. 1, 2020

(54) IMAGE FORMING APPARATUS, METHOD OF CONTROLLING THE SAME, STORAGE MEDIUM, AND SYSTEM

(71) Applicant: CANON KABUSHIKI KAISHA, Tokyo (JP)

(72) Inventors: Hiroaki Koike, Kokubunji-shi (JP); Atsushi Ikeda, Toride-shi (JP); Takeshi Kogure, Toride-shi (JP)

(21) Appl. No.: 16/820,779

(22) Filed: Mar. 17, 2020

(30) Foreign Application Priority Data
Mar. 28, 2019 (JP) 2019-064260

(51) Int. Cl. G06F 3/12

(52) U.S. Cl. CPC G06F 3/1238; G06F 3/1292; G06F 3/1256; G06F 3/1222

(57) ABSTRACT

An image forming apparatus notifies an authentication server of accepted authentication information of a user, obtains an authentication result, and determines whether or not information of a service that the user can access, the information included in the authentication result, can be supported by an application installed in the image forming apparatus. In addition, when it is determined as a result of the determination that a service that the user can access cannot be supported by the application, the image forming apparatus displays a message related to an update of the application on the display unit.

### BACKGROUND OF THE INVENTION

### Field of the Invention

The present invention relates to an image forming apparatus, a method for controlling the same, a storage medium, and a system.

### Description of the Related Art

In recent years, processing that cannot be performed on an image forming apparatus has been realized by using an external cloud service. Japanese Patent Laid-Open No. 2018-92564 proposes, when an external cloud service is used, using an external account of an external service to make a request to an external cloud server for sign up to the cloud service. As a result, it is possible to reduce the time and effort for inputting a passcode when signing in to the cloud service.

However, the above-mentioned prior art has the following problems. For example, when an external cloud service is used, a program corresponding to the respective service is installed in the image forming apparatus in order to make a processing execution instruction to the service. Execution instructions are given to respective services by executing these programs from an operation unit of the image forming apparatus. However, even if a new cloud service is added in such a service usage pattern, if a program installed in the image forming apparatus does not support the new service, the new service cannot be executed from the operation unit of the image forming apparatus.

### SUMMARY OF THE INVENTION

The present invention enables realization of a mechanism for, when a service that is not supported by an application installed in an image forming apparatus is included in services that can be accessed by a user, appropriately updating the application.

One aspect of the present invention provides an image forming apparatus comprising: at least one memory device that stores a set of instructions; and at least one processor that executes the set of instructions to: accept user authentication information and execute authentication; in a case where the authentication succeeds, determine whether information of a service, which a corresponding user can access and which is included in an authentication result, can be supported by an application installed in the image forming apparatus; and in a case where it is determined as a result of the determination that the service that the user can access cannot be supported by the application, display on a display unit a message related to an update of the application.

Another aspect of the present invention provides a method of controlling an image forming apparatus, comprising: accepting user authentication information and executing authentication; in a case where the authentication succeeds, determining whether information of a service, which the user can access and is included in the authentication result, can be supported by an application installed in the image forming apparatus; and in a case where it is determined as a result of the determination that the service that the user can access cannot be supported by the application, displaying a message related to an update of the application on a display unit.

Still another aspect of the present invention provides a non-transitory computer-readable storage medium storing a program for causing a computer to execute each step in a method of controlling an image forming apparatus, and method comprising: accepting user authentication information and executing authentication; in a case where the authentication succeeds, determining whether information of a service, which the user can access and is included in the authentication result, can be supported by an application installed in the image forming apparatus; and in a case where it is determined as a result of the determination that the service that the user can access cannot be supported by the application, displaying a message related to an update of the application on a display unit.

Yet still another aspect of the present invention provides a system that includes an image forming apparatus, an authentication server, and a plurality of servers providing a cloud service, wherein the image forming apparatus comprises: at least one memory device that stores a set of instructions; and at least one processor that executes the set of instructions to: notify accepted authentication information of a user to the authentication server, and obtain an authentication result, determine whether information of a service, which the user can access and is included in the authentication result, can be supported by an application installed in the image forming apparatus, and in a case where it is determined as a result of the determination that the service that the user can access cannot be supported by the application, display a message related to an update of the application on a display unit, and the authentication server comprises: a storage device configured to, for each cloud service provided by the plurality of servers, store access control information indicating whether or not access is possible in association with authentication information of each user, and an interface configured to execute authentication in response to a request from the image forming apparatus and transmit an authentication result that includes access control information of the user.

Further features of the present invention will become apparent from the following description of exemplary embodiments (with reference to the attached drawings).

### BRIEF DESCRIPTION OF THE DRAWINGS

FIG. 1 is a block diagram illustrating a hardware configuration of an MFP according to an embodiment.

FIG. 2 is a diagram illustrating a software configuration of an MFP according to an embodiment.

FIG. 3 is a view illustrating a system configuration according to an embodiment.

FIG. 4 is a diagram illustrating an example of an authentication cloud service setting screen according to an embodiment.

FIG. 5 is a diagram illustrating an example of display of a display unit according to an embodiment.

FIGS. 6A and 6B are a diagram illustrating a flow when a transmit button for a cloud service on the display unit of the MFP according to an embodiment is pressed.

FIGS. 7A-7C are a diagram illustrating processing when an unsupported service is included, according to an embodiment.

FIG. 8 is a diagram illustrating an example of a message display for prompting an application update according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

An image forming apparatus of the present embodiment can be applied as an information processing apparatus, an image processing apparatus, or an image forming apparatus that forms an image on a sheet by an electrophotographic method, such as a printing apparatus (printer), a copying machine, a multifunction peripheral (MFP), or a facsimile apparatus, for example. Incidentally, a multifunction peripheral is, for example, an apparatus that has a plurality—at least two or more—of functions among a plurality of types of functions including a print (printing) function, a scanning function, a copy function and a facsimile function. Here, a case where the image forming apparatus is a multifunction peripheral (MFP) will be described.

### MFP Configuration

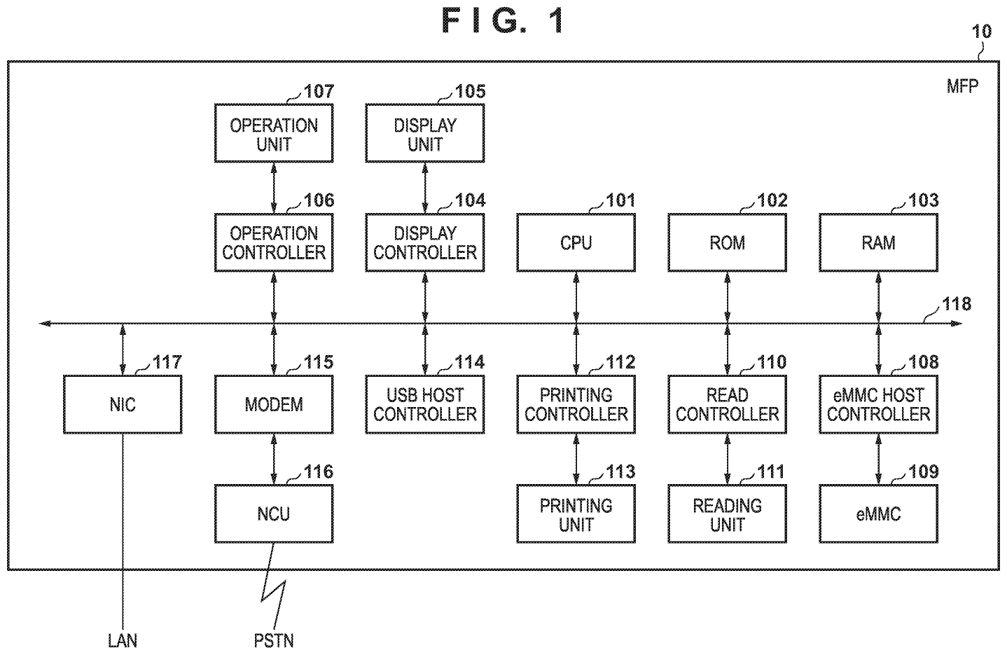

Hereinafter, an embodiment of the present invention will be described. First, the hardware configuration of an MFP according to the present embodiment will be described with reference to FIG. 1.

As illustrated in FIG. 1, the MFP 10 includes a CPU 101, a ROM 102, a RAM 103, a display controller 104, a display unit 105, an operation controller 106, and an operation unit 107. The MFP 10 includes an eMMC host controller 108, an eMMC 109, a read controller 110, a reading unit 111, a printing controller 112, and a printing unit 113. The MFP 10 further includes a USB host controller 114, a modem 115, a network control unit (NCU) 116, and a network interface card (NIC) 117.

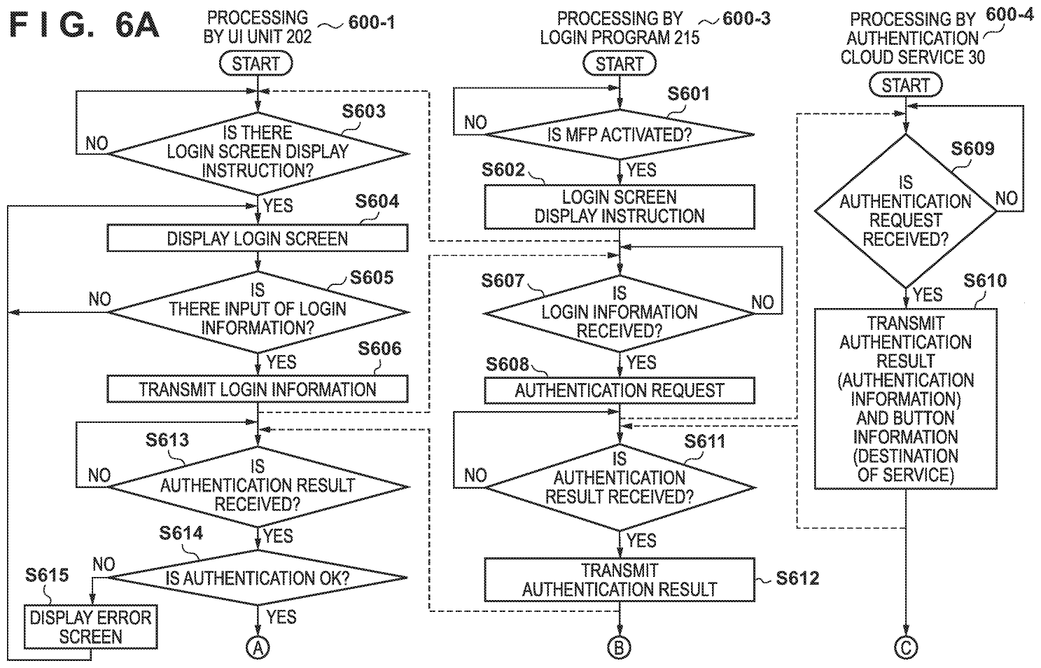

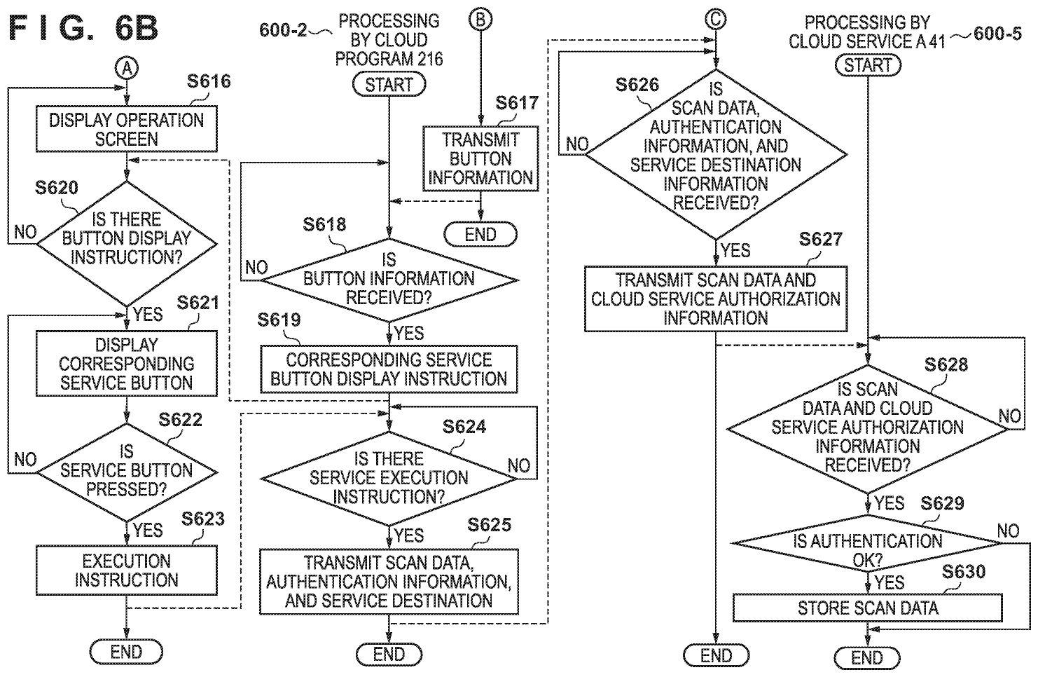

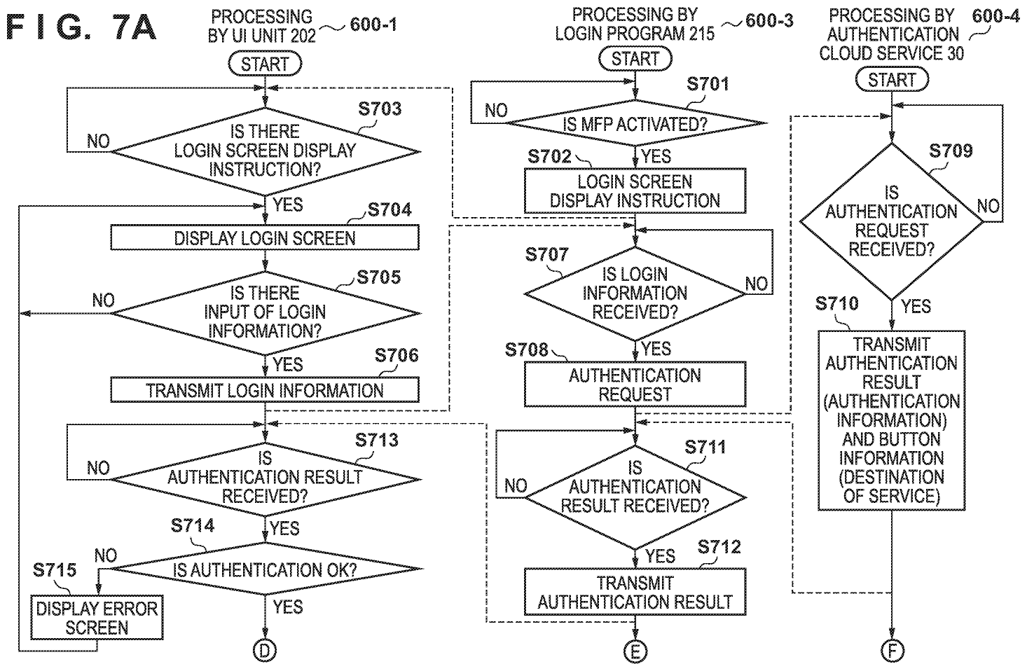

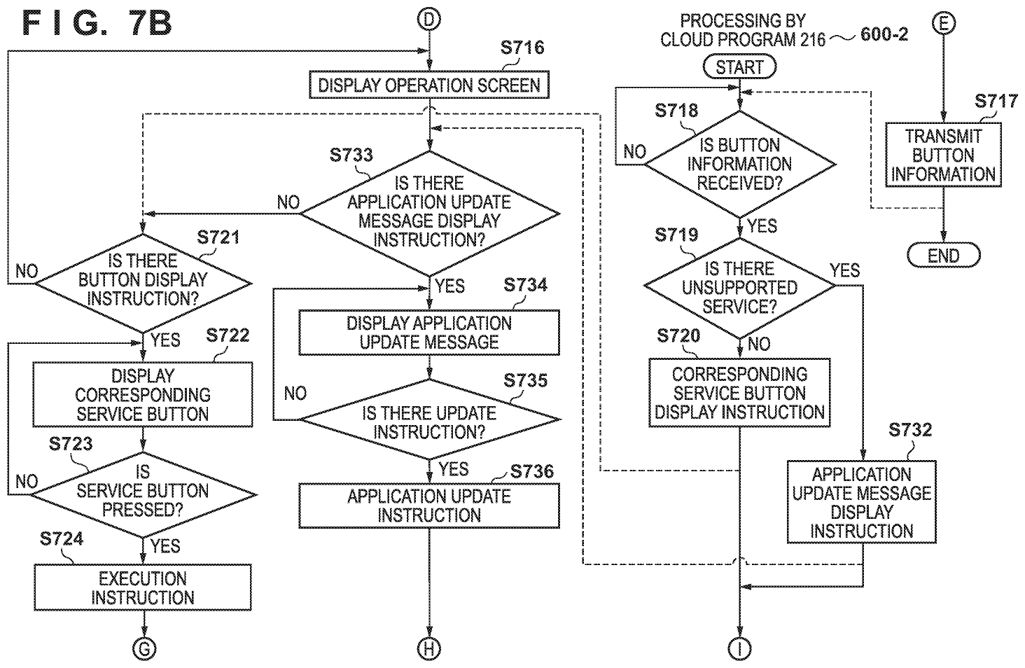

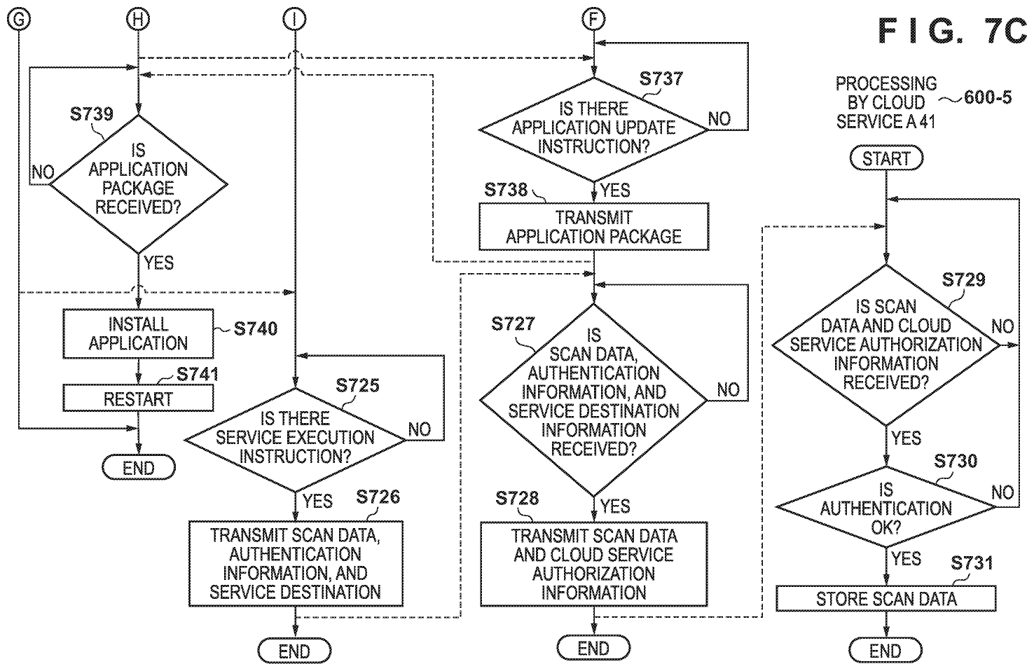

The CPU 101 collectively controls the devices connected to a system bus 118. When power is supplied, the CPU 101 executes a boot program stored in the ROM 102. Normally, the boot program loads a main program saved in a specific region of the eMMC 109 into the RAM 103, and jumps to the start of the loaded main program. The RAM 103 functions not only as a load location of the main program but also as a work area of the main program, for example. The CPU 101 executes various processes by executing processing flows described with reference to FIGS. 6 and 7.

The display controller 104 controls rendering on the display unit 105, which is a user interface. The display unit 105 is a full bitmap LCD of an WVGA size. In contrast, the operation controller 106 controls inputs from an operation unit 107 provided in the MFP 10. The operation unit 107 includes a touch panel overlapped with the display unit 105.

The reading unit 111 reads an original. An automatic document feeder (not illustrated) is attached to the reading unit 111 as an option, and a plurality of originals can be automatically read. The reading unit 111 is connected to the read controller 110, and the CPU 101 interacts with the reading unit 111 via the read controller 110. The printing unit 113 forms an image on a print sheet such as a sheet by an electrophotographic method. The printing unit 113 is connected to the printing controller 112, and the CPU 101 interacts with the printing unit 113 via the printing controller 112.

The USB host controller 114 handles USB protocol control and mediates access to a USB device such as a USB memory (not illustrated). The modem 115 modulates and demodulates signals necessary for facsimile communication. The modem 115 is connected to the NCU 116. The signal modulated by the modem 115 is transmitted to a public circuit network (PSTN) through the NCU 116. The NIC 117 performs two-way data exchange with, for example, email and file servers via a LAN. In addition, data is exchanged bidirectionally with a Web server or the like. The MFP 10 of the present embodiment includes the eMMC 109 as a storage. The CPU 101 accesses the eMMC 109 via the eMMC host controller 108.

### Software Configuration

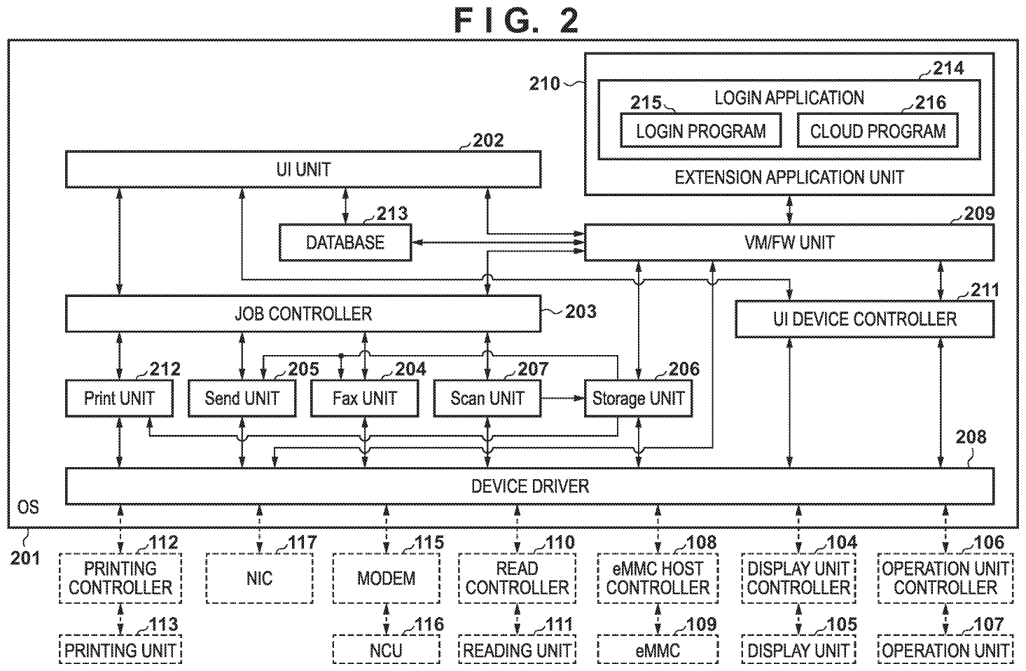

Next, the software configuration of the MFP 10 according to the present embodiment will be described with reference to FIG. 2. Each unit indicated by a solid line in FIG. 2 is a software module realized by the CPU 101 executing the main program loaded into the RAM 103 by the boot program described above.

The main program manages and controls the execution of each module described later by an OS (Operating System) unit 201. A device driver 208 is combined with the OS unit 201. The device driver 208 mediates interaction with hardware devices such as the display controller 104, the operation controller 106, and the read controller 110.

A UI (User Interface) unit 202 provides various information to the user via the display unit 105 and the operation unit 107, and accepts various instructions from the user. Various settings for switching the behavior of the MFP 10 can also be changed by the UI unit 202. The various settings changed by the UI unit 202 are physically stored in the eMMC 109 via a database 213. The setting of the display language changed by the UI unit 202 is also one of the various settings.

A job controller 203 accepts jobs such as copying, printing, and faxing, and controls execution of the accepted jobs. The storage unit 206 is a software module for physically storing, in the eMMC 109, and managing, for example, images to be sent or have been received by facsimile and data such as application settings requested from an extension application unit 210. For example, in the MFP 10 of the present embodiment, when the job controller 203 receives a fax transmission job, the scan unit 207 accepts the job request and controls the reading unit 111 to scan an original. Further, the scan unit 207 transfers the scanned facsimile image data to the storage unit 206. The storage unit 206 stores the transferred facsimile image data in the eMMC 109. The stored facsimile image data is read out by the fax unit 204, and subject to facsimile transmission to a counterparty via the modem 115 and the NCU 116. In contrast, image data received by facsimile from a counterparty via the modem 115 and the NCU 116 is fetched by the fax unit 204 and stored in the eMMC 109 by the storage unit 206.

The MFP 10 of the present embodiment includes a VM (Virtual Machine)/FW (Framework) unit 209. The extension application unit 210 is physically arranged in the eMMC 109 and accommodates a plurality of applications from programs written in scripting languages. For example, a language system such as Java (registered trademark) or Lua, which are interpreters for interpreting and executing bytecode, may be used. The VM/FW unit 209 installs a program written in a scripting language or a predetermined high-level language into the extension application unit 210. The VM/FW unit 209 also handles a role of uninstalling a program from the extension application unit 210. At the same time, the storage unit 206 holds status information of the application including whether an installed application is valid or invalid in the eMMC 109.

If there is an archive in the ROM 102 into which a plurality of pre-installed applications have been compressed, the VM/FW unit 209 also has the capability of decompressing and installing these applications into the extension application unit 210, as necessary. Details are omitted. The VM/FW unit 209 also handles mediation between functions realized by any program installed in the extension application unit 210 and existing functions. Then, the VM/FW unit 209 accepts the selection of the buttons displayed on the display unit 105, loads the scripting language of the corresponding applications on the RAM 103, and interprets and executes the contents of the scripting language. As a result, the MFP 10 of the present embodiment can easily realize an optional function such as a login application 214 while maintaining ability to detach the function. The login application 214 includes a login program 215 that manages MFP 10 authentication and a cloud program 216 that manages processing related to cloud services. Further, the VM/FW unit 209 refers to or changes various setting values of the database 213 in response to requests from a program installed in the extension application unit 210.

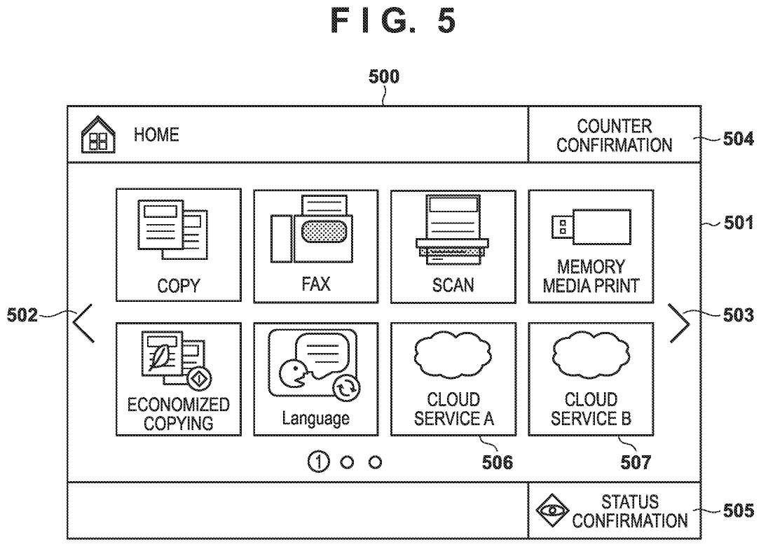

A UI device controller 211 mediates the output of various types of information to the display unit 105 by the UI unit 202 and the extension application unit 210, and the transmission of a user operation on the operation unit 107 to the UI unit 202 and the extension application unit 210. The cloud program 216 functions as an update control unit, and stores various settings such as scan attributes and transmission destination information for a user for transmitting a scan image to a cloud service 40, which will be described later, for example. In response to a request from the UI unit 202, the cloud program 216 which has stored various settings transfers, to the UI unit 202, icon data of a button 506 for a cloud service A 41 and icon data of a button 507 for a cloud service B 42, as illustrated in FIG. 5. Then, the UI unit 202 displays a menu screen 500 as illustrated in FIG. 5 on the display unit 105.

### Menu Screen

Here, an example of the display of the display unit 105 in the present embodiment will be described with reference to FIG. 5. The screen 500 is a menu screen on which various applications can be selected. Various buttons indicating the respective applications are displayed in reference numeral 501, and by pressing a button, an application corresponding to the respective button is activated and processing registered in advance in the buttons is executed. A predetermined number of buttons are displayed in a list at reference numeral 501, and regarding buttons that are not displayed, by pressing reference numeral 502 or 503, a transition is made to a display screen of a list of different buttons. By pressing 504 or 505, there is a transition to a screen for confirming the counter of the device or a screen for confirming the status of the device.

### System Configuration

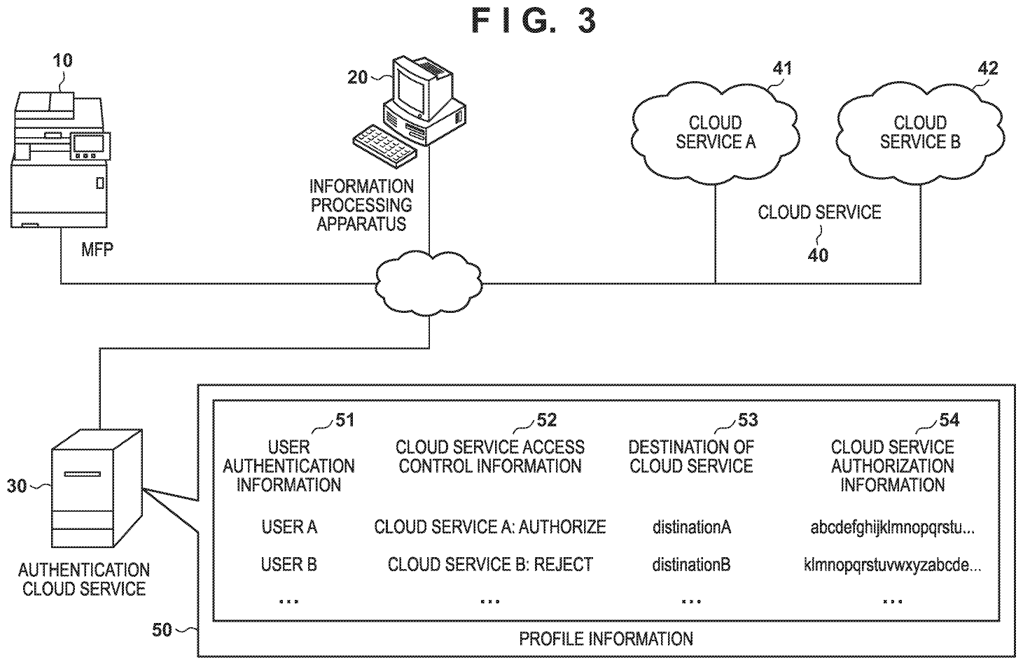

Next, with reference to FIG. 3, a system configuration (use environment) in the present embodiment will be described. The MFP 10 is connected via the Internet to an information processing apparatus 20, an authentication cloud service 30, and the cloud service 40 that includes the cloud service A 41, and the cloud service B 42. The MFP 10 transmits original data read by the MFP 10 reading unit 111 to the cloud service 40 such as the cloud service A 41 and the cloud service B 42. The information processing apparatus 20 is a user device that uses the MFP 10 or the cloud service 40, and can be applied to a device such as a personal computer, a tablet, a smartphone, or the like.

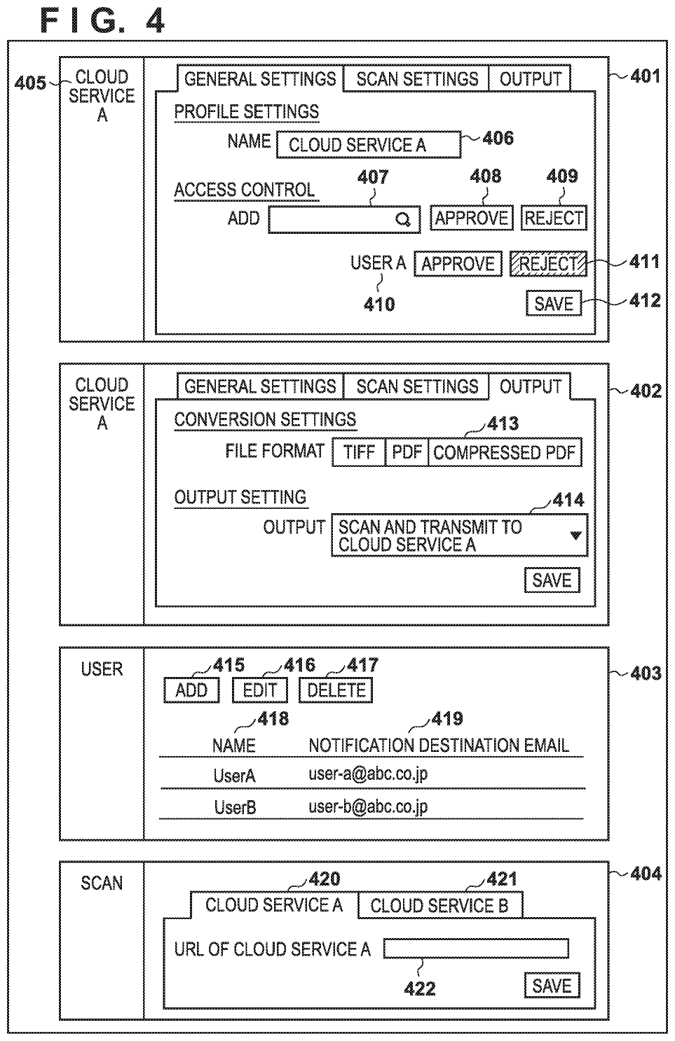

The authentication cloud service 30 stores profile information 50 that includes user authentication information 51, cloud service access control information 52, a service destination 53, cloud service authorization information 54, and the like. Here, the user authentication information 51 is user information for accessing the authentication cloud service 30. The cloud service access control information 52 is service information representing information on whether or not to authorize the user to access the cloud service. The cloud service access control information 52 is set by the MFP 10 using a setting screen of later-described FIG. 4, and is held by the setting information being received by the authentication cloud service 30. The service destination 53 is destination information of each cloud service 40. The cloud service authorization information 54 is authentication information that is used when the user accesses the cloud service 40.

### Settings Screen

Next, an example of a setting screen of the authentication cloud service 30 according to the present embodiment will be described with reference to FIG. 4. The setting screens illustrated in FIG. 4 are screens displayed when the authentication cloud service 30 is accessed from the Web browser of the information processing apparatus 20 illustrated in FIG. 3. The profile information 50 illustrated in FIG. 3 is generated in accordance with the information set here.

Setting screens 401 and 402 illustrated in FIG. 4 are screens for setting, in the menu screen 500, information associated with the button 506 for the cloud service A 41 and the button 507 for the cloud service B 42. In a text input field 405 of the setting screen 401, the name of a button displayed on the display unit 105 is set. When the user is designated in the text input field 407 for access control of the cloud service A and then an approve button 408 or a reject button 409 is pressed, a user name 410 and approval or rejection information 411 are added to the list display. By pressing a post-setting save button 412 on the setting screen 401, the set content is saved. As a result, a button having the button name designated in the text input field 407 and displayed on the display unit 105 (approval setting) or not displayed (rejection setting) is set for the user having the user name 410. The setting information is transmitted via a network to, for example, the authentication cloud service 30 (authentication server) which is an external device, and held as profile information 50. The MFP 10 may be configured to internally hold the functions of the authentication cloud service 30. In the screen of FIG. 5, the user A 410 has reject 411, and when the user A logs in to the MFP 10, the button 506 for the cloud service A is not displayed on the menu screen 500. In contrast, if the approval setting is set, a button 506 is displayed on the menu screen 500.

In a file format selection 413 of the setting screen 402, the user selects in which format from out of a TIFF format, a PDF format, and a compressed PDF format the original data read by the reading unit 111 is to be transmitted when the button of the display unit 105 is pressed. Note that these file formats are an example, and the present invention is not intended to be limited thereto. In an output setting 414, where to transmit the original data read by the reading unit 111 is set.

A setting screen 403 is a screen for managing user information. A user is added by pressing an add button 415 and inputting user information such as a name 418 and a notification destination email 419. The user information is edited or deleted by pressing an edit button 416 or a delete button 417. The setting screen 404 is a screen for setting a URL of the cloud service 40. When setting the cloud service A 41, the URL for the cloud service A 41 is set by selecting the tab 420 of the cloud service A 41 and inputting the URL in the displayed URL input field 422.

### Processing Flow 1

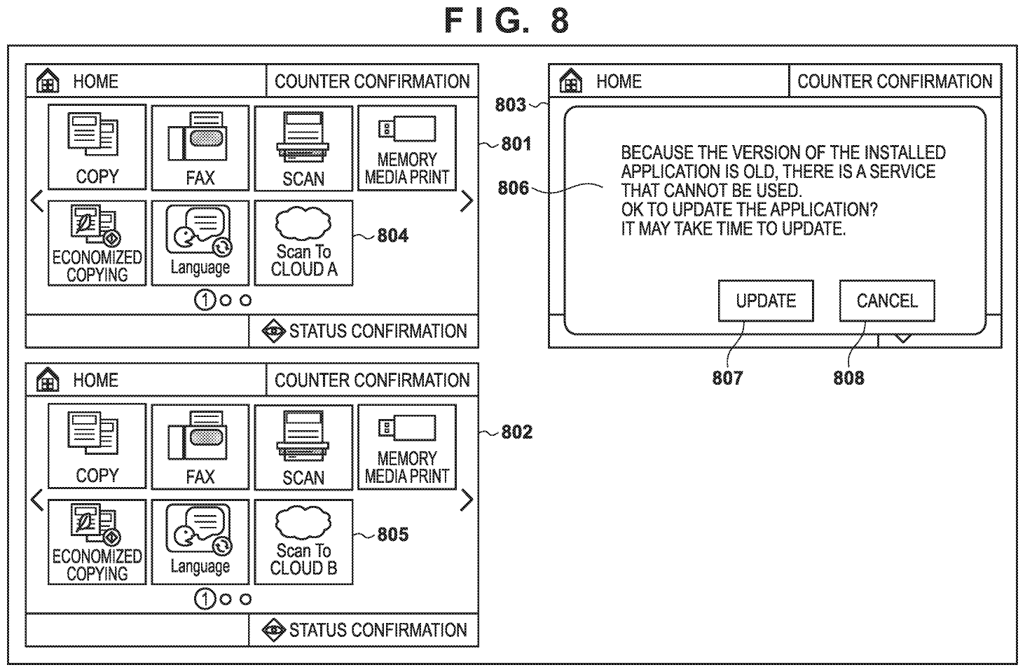

Next, with reference to FIGS. 6A and 6B, description is given for a processing procedure for when a transmit button 804 for the cloud service A 41 on the display unit 105 of the MFP 10 according to the present embodiment is pressed. Reference numeral 801 in FIG. 8 denotes a menu screen that includes the transmit button 804 for the cloud service A 41. Note that reference numeral 802 denotes a menu screen that includes a transmit button 805 for the cloud service B 42. In the processing described below, the processing of the login application 214 installed in the extension application unit 210 is interpreted by the VM/FW unit 209 and executed by the CPU 101. In FIGS. 6A and 6B, reference numeral 600-1 denotes processing of the UI unit 202, reference numeral 600-2 denotes processing of the cloud program 216, reference numeral 600-3 denotes processing of the login program 215, reference numeral 600-4 denotes processing of the authentication cloud service 30, and reference numeral 600-5 denotes processing of the cloud service A 41.

First, in step S601, the login program 215 determines whether or not the MFP 10 was activated. If the MFP 10 has not been activated, the processing returns to step S601 and the processing is repeated. If it is determined that the MFP 10 has been activated, the program proceeds to step S602, and the login program 215 instructs the UI unit 202 to display a login screen.

Meanwhile, in step S603, the UI unit 202 performs a determination of whether there is a login screen display instruction, and returns to step S603 and repeats the processing if it is determined that there is no login screen display instruction. When it is determined in step S603 that a login screen display instruction has been made, the processing proceeds to S604, and the UI unit 202 displays a login screen. Next, in step S605, the UI unit 202 performs a determination of whether login information has been inputted, and returns to step S604 and repeats the processing if it is determined that no login information has been inputted. When it is determined in step S605 that login information has been input, in step S606 the UI unit 202 transmits the login information to the login program 215.

In step S607, the login program 215 determines whether or not login information has been received, and returns to step S607 and repeats the processing if it is determined that login information has not been received. When it is determined in step S607 that login information is received, the login program 215 makes an authentication request to the authentication cloud service 30 in step S608.

In step S609, the authentication cloud service 30 determines whether or not an authentication request has been received, and returns to step S609 and repeats the processing if it is determined that an authentication request has not been received. When the authentication cloud service 30 determines in step S609 that an authentication request has been received, in step S610 the authentication cloud service 30 transmits an authentication result and button information to the login program 215. The authentication result includes an authentication result for the authentication cloud service 30, user authentication information 51 managed by the authentication cloud service 30, and cloud service access control information 52 (service information). The button information includes the destination 53 of the cloud service to which the user is authorized to access in the cloud service access control information 52, and the information set in the setting screens 401 and 402 in FIG. 4.

In step S611, the login program 215 determines whether or not an authentication result has been received, and returns to step S611 and repeats the processing if it is determined that an authentication result has not been received. When it is determined in step S611 that an authentication result is received, in step S612 the login program 215 transmits the authentication result to the UI unit 202.

In step S613, the UI unit 202 determines whether or not an authentication result has been received, and returns to step S613 and repeats the processing if it is determined that an authentication result has not been received. When it is determined in step S613 that the authentication result is received, the processing proceeds to step S614, and the UI unit 202 determines whether or not the authentication result is OK. If it is determined that the authentication result is not OK, in step S615 the UI unit 202 returns to step S604 and repeats the processing after displaying a message screen (not illustrated) indicating that the authentication result was NG (not good). On the other hand, when it is determined that the authentication result was OK, in step S616 the UI unit 202 displays an operation screen on the display unit 105.

After transmitting the authentication result in step S612, in step S617 the login program 215 transmits the button information to the cloud program 216. Here, the button information includes setting information that was set on the setting screens 401 and 402. Therefore, as described with reference to FIG. 3, the authentication cloud service 30 holds in advance the profile information 50 in a form in which the button information (the cloud service access control information 52) set in the setting screens 401 and 402 is linked to the user authentication information 51. Therefore, the authentication result includes information as to whether or not the authentication is successful, and access control information with respect to a service for the user.

In step S618, the cloud program 216 determines whether or not button information has been received, and returns to step S618 and repeats the processing if it is determined that button information has not been received. When it is determined in step S618 that button information has been received, in step S619, the cloud program 216 transmits, to the UI unit 202, an instruction for displaying the button of the cloud service authorized by the user in the button information (the cloud service access control information 52).

In step S620, the UI unit 202 performs a determination of whether there is a button display instruction, and returns to step S616 and repeats the processing if it is determined that there is no button display instruction. If it is determined in step S620 that there is a button display instruction, in step S621, the UI unit 202 displays a button of the corresponding service, for example, the transmit button 804 or the transmit button 805. Next, in step S622, the UI unit 202 performs a determination of whether a button of a service has been pressed, and returns to step S621 and repeats the processing if it is determined that a button of a service has not been pressed. If it is determined in step S622 that the service button has been pressed, in step S623, the UI unit 202 makes an execution instruction to the cloud program 216, and the processing of the UI unit 202 ends. Here, FIGS. 6A and 6B illustrates an example in which the transmit button 804 of the cloud service A 41 is pressed.

In step S624, the cloud program 216 determines whether or not a service execution instruction (a button press) has been received, If it is determined that there is no service execution instruction, the cloud program 216 returns to step S624 and repeats the processing. When it is determined in step S624 that a service execution instruction has been made, in step S625, the cloud program 216 transmits scan data read by the reading unit 111 of the MFP 10, the authentication information, and the service destination information to the authentication cloud service 30. Here, the cloud program 216 ends the processing.

In step S626, the authentication cloud service 30 determines whether or not scan data, authentication information, and service destination information have been received, and returns to step S626 and repeats the processing when it is determined that scan data, authentication information, and service destination information have not been received. When it is determined that scan data, authentication information, and service destination information have been received, in step S627 the authentication cloud service 30 transmits the scan data and the cloud service authorization information to the received service destination, and ends the processing of the authentication cloud service 30.

In step S628, the cloud service A 41 determines whether or not scan data and cloud service authorization information have been received, and returns to step S628 and repeats the processing when it is determined that scan data and cloud service authorization information have not been received. When it is determined in step S628 that scan data and cloud service authorization information have been received, the cloud service A 41 determines whether or not the authentication is OK in 629, and when it is determined that the authentication is not OK, the cloud service A 41 ends the processing without storing the scan data. When it is determined in step S629 that the authentication is OK, in step S630 the cloud service A 41 stores the scan data and then terminates the processing.

Here, the cloud service authorization information is authorization information set by each service with respect to the user, and is saved in the authentication cloud service 30 in association with the user. When the service button is pressed for the first time in step S622, the authorization information for the service is not set to the user in the authentication cloud service 30. In this case, a URL for obtaining the authorization information is transmitted to the destination of the notification destination email with respect to the user set in the setting screen 403 of FIG. 4. The user accesses the URL for obtaining the authorization information with the browser of the information processing apparatus 20, inputs login information on the displayed login screen, thereby setting the authorization information, and storing the information in the authentication cloud service 30. When the service button is pressed for the second time or later, the authorization information stored in the authentication cloud service 30 is used.

### Processing Flow 2

Next, with reference to FIGS. 7A-7C, a processing procedure when an application update screen is produced when a service not supported by the cloud program 216 according to the present embodiment is included in the button information will be described. In the processing described below, the processing of the login application 214 installed in the extension application unit 210 is interpreted by the VM/FW unit 209 and executed by the CPU 101. In FIGS. 7A-7C, reference numeral 600-1 denotes processing of the UI unit 202, reference numeral 600-2 denotes processing of the cloud program 216, reference numeral 600-3 denotes processing of the login program 215, reference numeral 600-4 denotes processing of the authentication cloud service 30, and reference numeral 600-5 denotes processing of the cloud service A 41. Since the processing from step S701 to step S718 is the same as the processing from step S601 to step S618, the description thereof is omitted here.

When it is determined in step S718 that button information has been received, the cloud program 216 determines whether or not a service not supported by the cloud program 216 is included in services that a user can access in the received button information in step S719. If it is determined in step S719 that a service not supported is not included, in step S720, the cloud program 216 transmits a button display instruction for the cloud service that the user is authorized for in the button information to the UI unit 202. Since the processing from step S721 to step S731 is the same as the processing from step S620 to step S630, the description thereof is omitted here.

Meanwhile, when it is determined in step S719 that there is a service that is not supported, in step S732, the cloud program 216 transmits an instruction to the UI unit 202 to display an application update message. Subsequently, in step S733, the cloud program 216 determines whether or not an instruction to display an application update message has been made, and when it is determined that there is no instruction to display an application update message, the processing advances to step S721. When it is determined in step S733 that an instruction to display an application update message has been made, in step S734, the UI unit 202 displays a message prompting an application update on the display unit 105. An example of a message display for prompting a user to update the application is illustrated at reference numeral 803 of FIG. 8. In a message display 806, a message for prompting application update, an update button 807, and a cancel button 808 are displayed. When the update button 807 is selected, the application is updated, the service is made available, and a button for the service is displayed on the menu screen. Details are described below.

Next, in step S735, the UI unit 202 determines whether or not the update button 807 has been pressed and there is an application update instruction. If it is determined that an application update instruction has not been issued, the processing returns to step S734 and the processing is repeated. When it is determined in step S735 that an application update instruction has been made, in step S736, an application update instruction is transmitted to the authentication cloud service 30. When the cancel button 808 is pressed, control to display the same menu screen as the previous one is performed.

In step S737, the authentication cloud service 30 determines whether or not there is an application update instruction, and when it is determined that there is no application update instruction, the processing returns to step S737 and the processing repeats. When it is determined that an application update instruction has been made, in step S738, the authentication cloud service 30 transmits an application package to the UI unit 202.

In step S739, the UI unit 202 determines whether or not an application package has been received, and returns to step S739 and repeats the processing if it is determined that an application package has not been received. When it is determined that an application package has been received, in step S740, the UI unit 202 performs processing for installing the application. After the application install processing is executed, in step S741, the UI unit 202 performs a restart of the MFP 10, and the processing of the UI unit 202 ends.

As described above, a system according to the present embodiment includes an image forming apparatus, an authentication server (the authentication cloud service 30), and a plurality of servers (the cloud service 40) that provide the cloud service. The image forming apparatus notifies the authentication server of the accepted authentication information of the user, obtains an authentication result, and determines whether or not information of a service that the user can access, the information included in the authentication result, can be supported by an application installed in the image forming apparatus. When it is determined as a result of the determination that a service that the user can access cannot be supported by the application, the image forming apparatus displays a message related to an update of the application on the display unit. The authentication server has a storage unit that stores, for each cloud service provided by a plurality of servers, access control information indicating whether or not access is possible in association with authentication information of each user, executes authentication in response to an authentication request, and transmits an authentication result including the access control information of the user. As described above, in the present embodiment, the cloud program 216 confirms a service support status of the cloud program 216 based on the received access control information (button information). Further, according to the present embodiment, when the application installed in the image forming apparatus does not support a service that can be accessed by the user, a message prompting an update of the application is displayed. Note that the login information received by the authentication cloud service 30 may include information of a service supported by the cloud program 216, so that the authentication cloud service 30 may make a support status confirmation of services of the cloud program 216.

### Variation

The present invention is not limited to the above-described embodiments, and various modifications are possible. For example, in the above embodiment, when the button information (cloud service access control information 52) includes a service that cannot be supported by the application of the MFP, a message prompting an update is displayed. However, the present invention is not limited to this, and, for example, the update of the application may be automatically performed instead of requesting the approval of the user as in the above embodiment, and a message indicating that the update is being performed may be displayed. As a result, operation by a user can be reduced. Further, control may be performed so that it is possible to set whether to perform an update automatically or request user approval. That is, the present variation can be executed in combination with the above-described embodiment, and which control is selected may be set by an administrator or the like.

The present invention enables, when a service that is not supported by an application installed in an image forming apparatus is included in services that can be accessed by a user, appropriately updating of the application.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-064260, filed Mar. 28, 2019, which is hereby incorporated by reference herein in its entirety.

What is claimed is:

1. An image forming apparatus comprising:
at least one memory device that stores a set of instructions; and
at least one processor that executes the set of instructions to:
accept user authentication information and execute authentication;
in a case where the authentication succeeds, determine whether information of a service, which a corresponding user can access and which is included in an authentication result, can be supported by an application installed in the image forming apparatus; and
in a case where it is determined as a result of the determination that the service that the user can access cannot be supported by the application, display on a display unit a message related to an update of the application.

2. The image forming apparatus according to claim 1, wherein
the at least one processor executes instructions in the memory device to:
transmit the accepted authentication information to an authentication server via a network to obtain the authentication result,
the authentication server holds in advance information on accessible services in association with authentication information for each user.

3. The image forming apparatus according to claim 2, wherein
the at least one processor executes instructions in the memory device to:
set user access control for each service according to user input, and notify the set information to the authentication server.

4. The image forming apparatus according to claim 1, wherein
the at least one processor executes instructions in the memory device to:
display on the display unit a screen including a message prompting a user to update the application as a message related to the update of the application, and upon user approval is accepted via the screen, execute the update of the application.

5. The image forming apparatus according to claim 1, wherein
the at least one processor executes instructions in the memory device to:
as a message related to the update of the application, display on the display unit a message to a user indicating that the application is being updated, and automatically execute the update of the application.

6. The image forming apparatus according to claim 4, further comprising:
a user interface configured to display on the display unit a menu screen that allows a service that is newly added to be selected upon an application is updated.

7. The image forming apparatus according to claim 2, wherein
a service that a user can access includes a cloud service that is accessible via a network, and
the at least one processor executes instructions in the memory device to:
when updating the application, make an inquiry to the authentication server to obtain an application package of the cloud service.

8. The image forming apparatus according to claim 7, wherein
in response to the inquiry, the authentication server obtains the application package from a server of the cloud service.

9. A method of controlling an image forming apparatus, comprising:
accepting user authentication information and executing authentication;
in a case where the authentication succeeds, determining whether information of a service, which the user can access and is included in the authentication result, can be supported by an application installed in the image forming apparatus; and
in a case where it is determined as a result of the determination that the service that the user can access cannot be supported by the application, displaying a message related to an update of the application on a display unit.

10. A non-transitory computer-readable storage medium storing a program for causing a computer to execute each step in a method of controlling an image forming apparatus, and method comprising:
accepting user authentication information and executing authentication;
in a case where the authentication succeeds, determining whether information of a service, which the user can access and is included in the authentication result, can be supported by an application installed in the image forming apparatus; and
in a case where it is determined as a result of the determination that the service that the user can access cannot be supported by the application, displaying a message related to an update of the application on a display unit.

11. A system that includes an image forming apparatus, an authentication server, and a plurality of servers providing a cloud service, wherein
the image forming apparatus comprises:
at least one memory device that stores a set of instructions; and
at least one processor that executes the set of instructions to:
notify accepted authentication information of a user to the authentication server, and obtain an authentication result,
determine whether information of a service, which the user can access and is included in the authentication result, can be supported by an application installed in the image forming apparatus, and
in a case where it is determined as a result of the determination that the service that the user can access cannot be supported by the application, display a message related to an update of the application on a display unit, and
the authentication server comprises:
a storage device configured to, for each cloud service provided by the plurality of servers, store access control information indicating whether or not access is possible in association with authentication information of each user, and
an interface configured to execute authentication in response to a request from the image forming apparatus and transmit an authentication result that includes access control information of the user.

12. The system according to claim 11, wherein
the at least one processor executes instructions in the memory device to: when updating the application, obtain an application package from a server of a corresponding cloud service via the authentication server and execute an update of the application package.
